(19) United States
(12) Patent Application Publication
(10) Pub. No.: US 2003/0154128 A1
(43) Pub. Date: Aug. 14, 2003

(54) Communicating and displaying an advertisement using a personal video recorder

(76) Inventors: Kevin M. Liga, Rye Brook, NY (US); Michael G. Cristofalo, Doylestown, PA (US); Frank P. Deo, Flemington, NJ (US); Arthur L. Greenberg, Annandale, NJ (US)

Correspondence Address: DORSEY & WHITNEY LLP-DENVER, SUITE 4700, 370 SEVENTEENTH STREET, DENVER, CO, 80202-5647, US

(21) Appl. No.: 10/074,530

(22) Filed: Feb. 11, 2002

(51) Int. Cl. H04N 5/91; H04N 7/04; H04N 7/06; H04N 7/08; H04N 7/52

(52) U.S. Cl. 705/14; 386/95

(57) ABSTRACT

A method and system for displaying updated, targeted, and/or alternately formatted advertisements to a consumer. The invention may use targeted ads in conjunction with consumer profile information to reach interested consumers. The invention may further detect stale advertisements and replace them with updated advertisements having timely information. The updated advertisements are displayed in place of the stale commercials. The invention may also display alternately formatted advertisements in place of speeded-up advertisements during a fast-forward operation on a personal video recorder. Reward-based content may also be provided, wherein the content is viewable only after one or more advertisements are viewed at normal playback speed. All of these functions are operable with a personal video recorder.

### TECHNICAL FIELD

The invention relates generally to digital broadcasting systems and methods, and more specifically to a personal video recorder operative to receive a digital broadcast.

### BACKGROUND

Every form of mass communications has advertisements of one sort or another. Radio broadcasts have voice ads, newspapers carry print ads, and television broadcasts contain video commercials. Advertisements have traditionally been played in real-time during a transmission or are printed on a page. Such advertisements thus must be noticed by a consumer, even if only to turn the page or change the channel. The consumer, however, traditionally was required to view or listen to an advertisement in order to continue listening to, reading, or watching the information or programming in which the advertisement is contained. Television ads, in particular, created strong impressions on the public who sat through them in order to see the continuation of a program.

This changed completely with the advent of video recorders. Video cassette recorders (VCRs) allowed a consumer to record a program and watch it at a later time. In addition to time-shifting, VCRs also permitted a consumer to fast-forward through or skip entirely an advertisement, thus nullifying its effectiveness. Even when fast-forwarding, the advertisement was played at high speeds and often without sound, thus creating a jumbled collage which had no consumer impact at all.

With the widespread use of personal video recorders (PVRs), advertisements became even less watched. The typical PVR is a digital device capable of storing programming on a magnetic storage device such as a hard disk and playing back the programming with near-perfect quality. Most PVRs have vastly expanded recording capabilities when compared to VCRs. For example, the average PVR can store at least thirty hours of programming, as compared to four or six on a video tape. A PVR can even record a program and play it back simultaneously, which permits a consumer to begin watching a program after the broadcast starts, skip the intervening commercials, and finish the program at approximately the same time the broadcast ends. This greatly diminishes an advertisement's ability to reach a consumer.

Accordingly, there is a need in the art for an improved method and system for displaying advertisements in conjunction with a personal video recorder.

### SUMMARY OF THE INVENTION

Generally, the present invention comprises a method and system for displaying updated or alternately formatted advertisements to a consumer. The invention may use targeted ads in conjunction with consumer profile information to reach interested consumers. Consumer profile information tracks what goods or services are particularly suited to a given consumer. Specific advertisements thus may be tailored to appeal to specific consumers. Advertisements meeting selection criteria based on the profile information may be stored on a personal video recorder (PVR) for quick and simple viewing. The advertisements may either be downloaded directly from a headend server, or may be captured by the PVR from normal television channels at a specific search time.

The invention may also encode advertisements with hidden information that is only seen or otherwise activated when a consumer fast-forwards through a recording.

By embedding data in the vertical blanking interval (VBI) or horizontal overscan region of a programming signal, or by transmitting embedded data as discrete data packets in a digital stream, additional data may be communicated to a PVR without being seen by the consumer. When a consumer attempts to fast-forward past an advertisement, the invention may retrieve the embedded data to provide a display other than the standard advertisement. For example, the PVR may show a series of still frames designed to be displayed for a certain amount of real time during a fast-forward operation, effectively displaying a viewable, if truncated, advertisement in storyboard form instead of the speeded-up normal advertisement. Alternately, a single frame may be shown during the entire fast-forward operation, or a sound clip might be played.

The invention may also freshen or replace stale advertising. An advertisement may be encoded or embedded with a hidden time or date stamp indicating when an advertisement expires. As the PVR plays back a recorded video signal, it may check the embedded information before an advertisement is actually shown. Should the embedded stamp indicate that an advertisement is stale, the PVR may substitute an updated advertisement. Updated advertisements may either be requested from and transmitted by a server located at a cable headend or other transmission source, or may be stored locally on the PVR itself. In either case, the downloading and playing of a new advertisement in place of a stale one is substantially instantaneous.

The invention may also provide reward-based content. A free and otherwise inaccessible program may be provided to a consumer. The invention may limit or eliminate a consumer's ability to view an otherwise free program should the consumer attempt to fast-forward or skip advertisements contained within the program. Essentially, the invention may disable a consumer's remote control (or merely the fast-forward capability thereof) and thus his ability to skip commercials. Should this disablement be circumvented, then the invention may terminate playing the free program.

The invention is more fully described with respect to the drawings below.

### BRIEF DESCRIPTION OF THE DRAWINGS

FIG. 1 displays an exemplary operating environment for an embodiment of the present invention.

FIG. 2 displays a personal video recorder operative with an embodiment of the present invention.

FIG. 3 displays an embodiment of the present invention within an operating environment.

FIG. 4 is a flowchart of a method of operation for scanning for and capturing digital advertisements.

FIG. 5 is a flowchart of a method for streaming digital advertisements from a storage source to a programming signal.

FIG. 6 is flowchart of a method for displaying alternately formatted advertisements during a fast-forward operation.

FIG. 7 is a flowchart of a method for updating stale advertisements.

FIG. 8 is a flowchart of a method for playing reward-based content.

### DETAILED DESCRIPTION

Generally, the invention comprises a method and system for displaying one or more advertisements on a television through the use of a personal video recorder (PVR). In this context, a personal video recorder includes any device capable of receiving a digital video stream and storing the stream in a digital, rather than analog, format. Examples of PVRs include the TIVO® system, manufactured by TiVo Inc. of Alviso, Calif.; the ReplayTV system, manufactured by Replay TV, Inc. of Mountain View, Calif.; and the Ultimate TV system, manufactured by Microsoft Corp. of Redmond, Wash. PVRs typically include one or more internal storage devices, often in the form of hard drives, used to digitally record an audiovisual signal. The signal may then be replayed at a later date.

By either properly configuring the headend of a cable system or via transmitting appropriate instructions to the PVR, the PVR's recording and play capabilities may be used in various manners to enhance advertisements playing on a television broadcast. It should be noted that a “television broadcast” encompasses any television program transmitted as a digital signal, including cable, satellite, microwave, or digital subscriber line (DSL) transmissions, and so forth. Alternate embodiments may employ these methods with traditional analog signals.

In one embodiment, targeted ads may be combined with PVR capabilities to increase the likelihood that a consumer will pay attention to advertisements placed during a television program. Consumer profile information may be used to determine what goods or services are particularly suited to a given consumer. For example, the age, income, and educational level of different consumers owning PVRs may be collected. This information, for example, may be collected via consumers' responses to warranty cards, on-screen voluntary surveys, or simply by collecting “click-through” data from monitoring a consumer's instructions to a PVR to fast forward past certain commercials while watching others. From this information, specific advertisements may be tailored to appeal to a consumer, rather than employing a shotgun approach to advertising. Advertisements meeting selection criteria based on the profile information may be stored on the PVR for quick and simple viewing. The advertisements may either be downloaded directly from a headend server, or may be captured by the PVR from normal television channels at a specific search time.

In another embodiment, advertisements may be encoded with hidden information that is only seen or otherwise activated when a consumer fast-forwards through a recording stored on a PVR. By embedding data in a portion of the video signal not normally seen on a standard television display, such as the vertical blanking interval (VBI) or horizontal overscan region, additional data may be communicated to a PVR. Alternately, embedded data may be transmitted as separate data packets in the data stream comprising the video signal, or in network signals such as Society of Cable Telecommunications Engineers (SCTE) standards, such as the DVS 253 standard for cueing advertisements, or the DVS 380 API message, for inserting advertisement data received from a network. When a consumer presses the fast-forward control on a remote, the PVR accesses the embedded data to provide a display other than the standard advertisement during the time the ad would normally be displayed. That is, instead of seeing a typical advertisement played at high speed during a fast-forward operation intended to speed past the ad, a consumer will see whatever the embedded data instructs the PVR to display. For example, the embedded data may contain a series of still frames designed to be displayed for a certain amount of real time during a fast-forward operation, effectively displaying a viewable advertisement in storyboard form. Alternately, a single frame may be shown during the entire fast-forward operation in order to maximize impact on a consumer. As yet another option, a jingle, short piece of music, or other audio segment might be played instead of providing a visual cue.

A third embodiment of the present invention permits the freshening or replacement of stale advertising. Each advertisement may again be encoded or embedded with hidden information. In this embodiment, the hidden information is typically a time or date stamp indicating when an advertisement expires. As the PVR plays back a recorded video signal, it may check the embedded information as each advertisement is queued for playback. Should the embedded information indicate that an advertisement is stale, the PVR may substitute an updated advertisement. Updated advertisements may either be requested from and transmitted by a server located at a cable headend or other transmission source, or may be stored locally on the PVR itself.

A fourth embodiment links advertisements to reward-based content. Reward-based content may be played from a recording stored on a PVR. The reward-based content generally has one or more advertisements placed at some point within the content. The embodiment disables a consumer's remote, ensuring that the consumer must watch the advertisements in order to continue viewing the reward-based content. Should the consumer somehow skip the advertisements or turn off the PVR, the reward-based content playback terminates and will not play again.

Exemplary Operating Environment

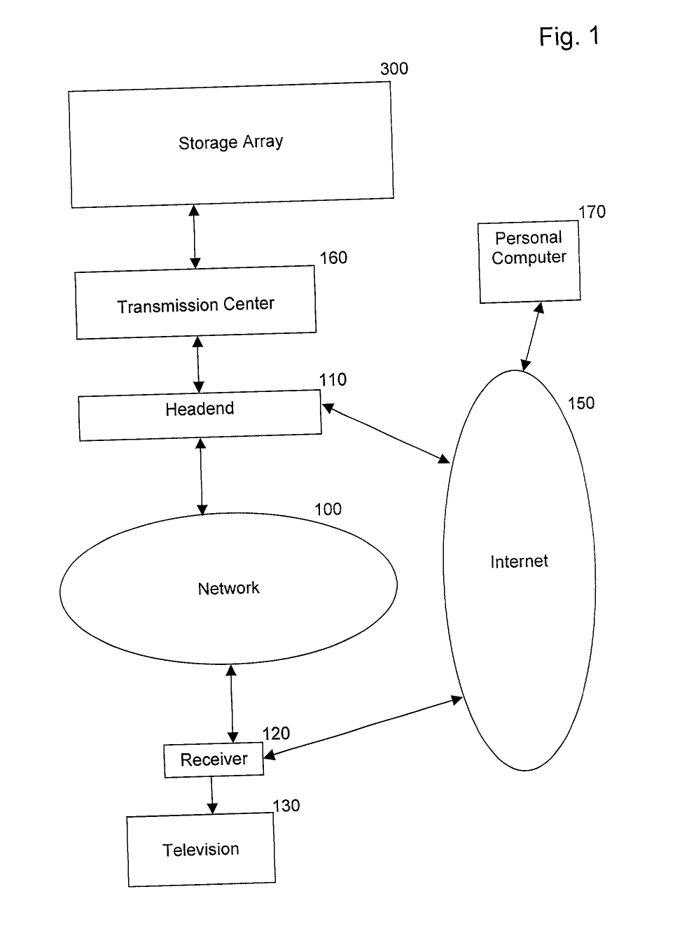

Referring to FIG. 1, an exemplary operating environment for the present invention, inclusive of multiple preferred embodiments, is disclosed. The programming transmission center 160, generally a cable or satellite television transmission station, or an Internet hosting site, broadcasts a programming signal across a network 100. The programming signal may contain a variety of audiovisual data, including targeted advertisements, to connected subscribing consumers. The headend 110 acts as a gateway, controlling and monitoring the flow of programming signals and other data to and from the transmission center 160 across the network 100. In some embodiments, the headend may be omitted without affecting the operation of the invention. For example, satellite- or Internet-based embodiments may lack a headend.

A receiver 120 at a consumer's location receives the programming signal and processes the signal for presentation on an attached television 130. The receiver 120 may be a set-top box, circuitry and software resident on the television 130 itself, or a computer with appropriate video cards and software. Throughout this application, the terms “receiver” and “set-top box” are used interchangeably, and both should be construed to refer to all of the aforementioned configurations and their equivalents.

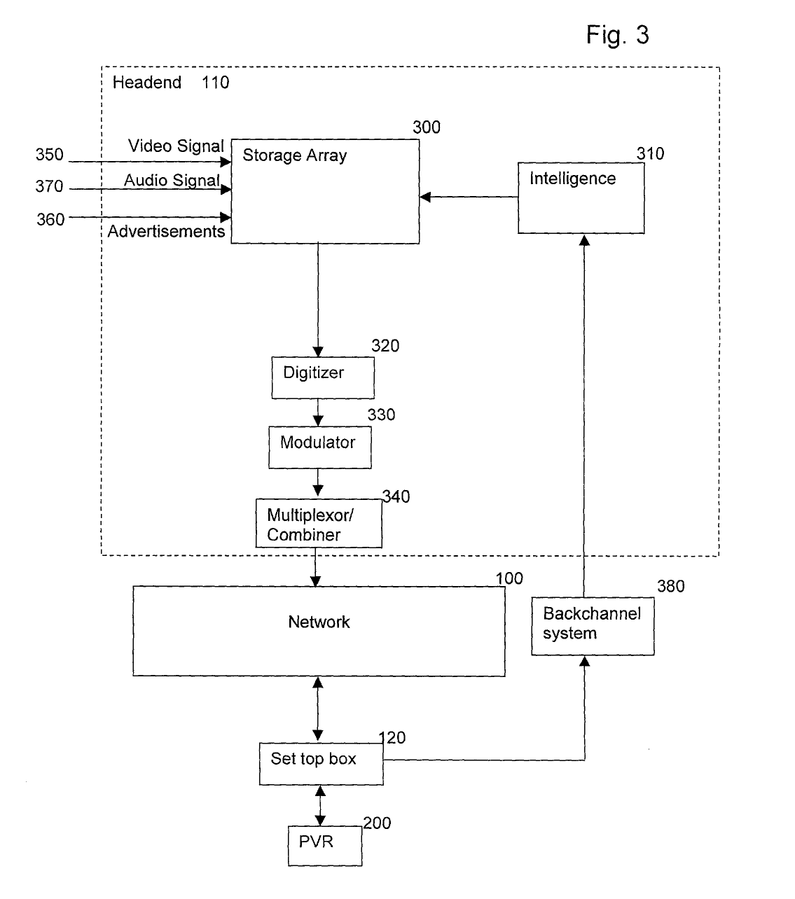

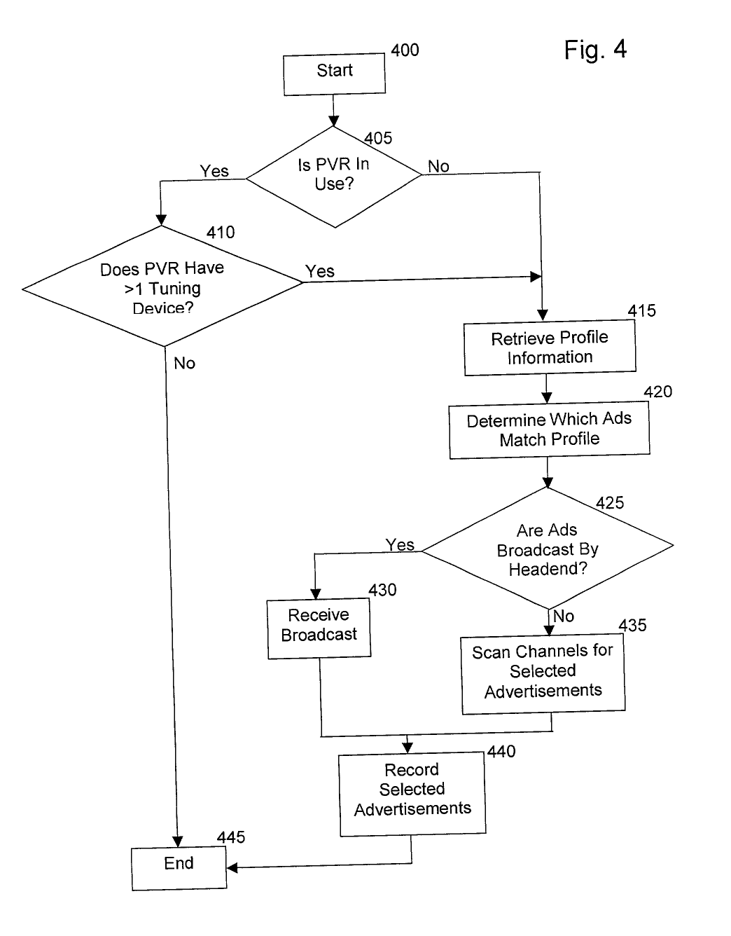

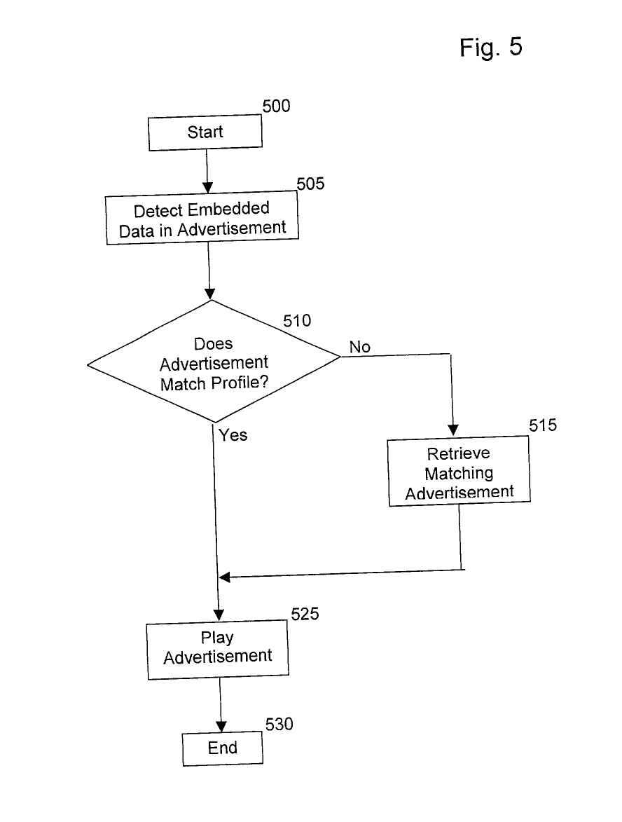

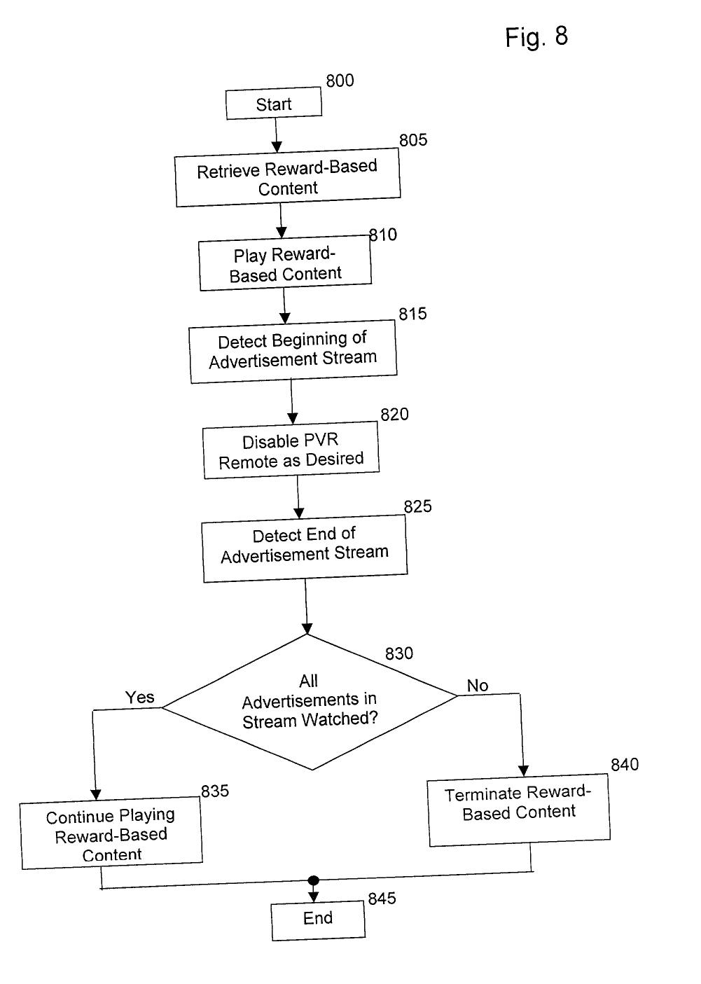

The television 130 presents regular television programming and/or audiovisual signals and, with respect to the present invention, targeted advertisements and/or reward-based content. The programming signal includes audiovisual signals as shown in FIG. 3, which collectively include video signals 350, audio signals 370, and advertisements 360. It should be noted that the advertisement signal 360 may be formatted in exactly the same manner as the video signals 350 and audio signals 370, but may simply come from a different source (i.e., the advertiser or another programming source). These audiovisual signals comprise network programming, targeted advertisements, reward-based content, and so forth. Targeted advertising is discussed more fully with respect to FIGS. 4 and 5, while reward-based content is explained with respect to FIG. 8. In other embodiments, audiovisual signals may include Internet content or other communication network content. The terms “programming signal” and “audiovisual signal” are used interchangeably throughout this document.

Programming signals may be stored on any applicable storage device in a storage array 300 located at the headend 110. Generally speaking, the storage array 300 comprises one or more storage devices linked to a network 100, and may store advertisement signals 360, video signals 350, audio signals 370, video-on-demand (VOD) programs, and so forth. Sample storage devices include as magnetic tapes, disks, or other magnetic storage/playback media, optical disks or other optical storage/playback media, or a computer, video, or MPEG server. Programming signals may also come from Internet content accessed from a web page housed in a remote server. Alternatively, the transmission center 160 could instruct the receiver 120 to access Internet 150 content, such as a World Wide Web (WWW) page or a file transfer protocol (FTP) server. Programming signals could be accessed from the Internet by, for example, the use of streaming video technology. If desired or necessary, additional communications links may connect the network 100 to other public networks, or a private network or intranet, for accessing content thereon (not shown). Additionally, programming signals may be received by the transmission center 160 from a remote broadcast source, such as a television network, satellite broadcast, or advertiser feed, and retransmitted to consumers. Audiovisual signals may incorporate segments from any of these mediums or sources by switching among them for programming material, and may include audio, video, graphics, text, or Internet content.

The Personal Video Recorder

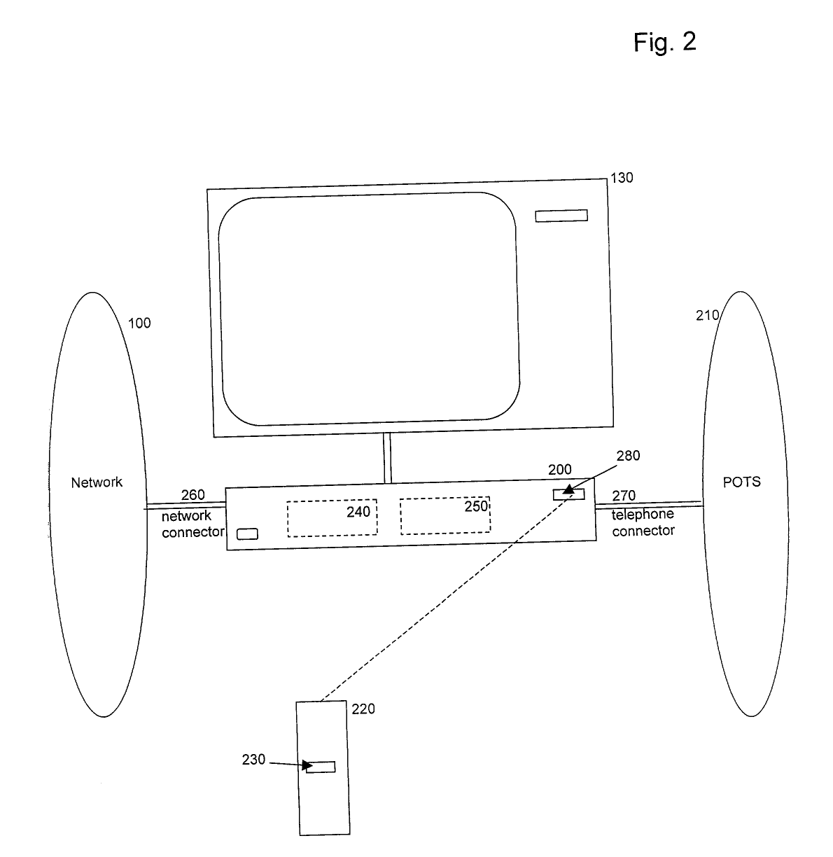

FIG. 2 displays an exemplary personal video recorder (PVR) 200 suitable for use with an embodiment of the present invention. It should be noted that the PVR 200 may be included in a set top box 120 or other receiver (or vice versa), although generally the two items are separate. Typically, the set top box acts as a gateway between a consumer's television 130 and/or PVR 200 and the network 100, while the PVR 200 serves to record and store signals passed along via the set top box.

A brief description of a PVR's operation may aid in understanding the operation of the invention. Generally, a personal video recorder 200 receives a broadcast signal consisting of audio and/or video data from a cable network 100 across a cable connector 260. The PVR 200 is further connected via a telephone connector 270 to a telephone network (“POTS”, or “plain old telephone system”) 210 in order to receive programming and scheduling information. The PVR 200 is additionally connected to a television 130 in order to provide a display for a recorded (or live) broadcast signal.

A PVR typically includes at least a first storage device 240, and often a second storage device 250. These storage devices generally take the form of magnetic-writeable storage, such as a typical hard drive. Although FIG. 2 displays the first storage device 240 and second storage device 250 as physically unique elements, the storage devices 240, 250 may be partitions of a single hard disk or other magnetic-writeable storage. When a consumer instructs the PVR 200 to record a program or other broadcast signal, the PVR converts the signal to a digital format and stores it on the storage device 240. Further, if the PVR 200 has multiple read/write heads connected to a single storage device 240 or multiple storage devices 240, 250, then the PVR may record an incoming signal while playing back previously recorded data. The playback data may be a program recorded during a previous session, or may be the same broadcast signal currently being recorded. Indeed, one reason for the current popularity of PVRs 200 is that, unlike a tape-based video recorder, a consumer may record a broadcast signal while watching pre-recorded data. Many consumers use this ability to time-shift a program by only a few minutes. That is, consumers may record a program and begin playing back the same program from the start while the PVR 200 continues to record the program. Oftentimes consumers will use this ability to begin watching a program after the start time, skip through the recorded advertisements, and, by virtue of the time gained by skipping ads, finish watching the program as a real-time broadcast.

The term “real-time” is used throughout this document to denote a playing or viewing time corresponding to a non-fast-forwarded playback of a video signal, as distinguished from “fast-forward-time,” or the amount of time required to replay a video signal while fast-forwarding. Thus, an advertisement taking thirty seconds of real-time play may require only five seconds of fast-forward-time to skip, presuming that the PVR's 200 fast-forward feature speeds up playback by six times.

Typically, a PVR 200 lacks controls on its body other than a power switch. Instead, the PVR 200 is controlled via remote 220. Among other controls, the remote 220 includes a fast-forward control 230 permitting a consumer to speed up playback of recorded data in order to skip over certain elements.

The PVR 200 is generally connected to the network 100 by a network connector 260 in order to receive programming signals broadcast by the transmission center 160. The PVR 200 may also be connected to a telephone network 210 via a telephone connector 270. The PVR downloads programming information through the telephone connector 270, and may retrieve additional specialized information as well.

Operation of an Embodiment

FIG. 3 displays an embodiment of the present invention configured to operate within the exemplary environment discussed with respect to FIG. 1. A headend 110 contains a storage array 300, an intelligence 310, a digitizer, 320, a modulator 330, and a multiplexor 340. The headend 110 may contain additional components, or may omit one or more of these items. Each of these components will be discussed in turn.

A storage array 300 contains multiple storage devices, including, for example, magnetic and optical storage devices. The storage array 300 accepts and stores multiple audiovisual signals, such as a video signal 350 and advertising signal 360. The video signal 350 may come from any number of sources, such as a videotape, a remotely broadcast microwave or satellite signal, a linear analog television feed, and so forth. Similar sources may be used for the advertising signal 360.

An intelligence 310 is also connected to the storage array 300. The intelligence generally controls the operation of the storage array, determining when to accept and store a video signal 350, when to broadcast signals, how to apply any business rules in effect for the particular broadcasting system, and so forth. The intelligence may be a processor with a memory, code running on such a processor or stored in the memory, a combination of both, or any other such means known to those skilled in the art.

When the storage array 300 broadcasts a stored signal, the signal is initially converted by a digitizer 320 to a digital format compatible with the network 100 over which the signal will ultimately be broadcast. Following digitization, the signal is passed to a modulator 330. The modulator 330 regulates the amplitude and/or frequency of the digital signals 350, 360 in order to control the amount of bandwidth required to transmit the signals across the network 100. Once modulated, the digital signals are combined with standard network channel broadcasts by the multiplexor 340. Note that the multiplexor 340 may employ time division multiplexing, frequency division multiplexing, or code division multiplexing depending on the requirements of the network 100. Once multiplexed, the signal is broadcast across the network 100. Alternately, the positions of the multiplexor 340 and the modulator 330 may be swapped, so that multiple signals are first multiplexed and then modulated.

A set-top box 120 is also connected to the network and locally receives the digital signal sent out by the headend 110. The set top box acts as a gateway between a consumer's television 130 and/or PVR 200 and the network 100. Essentially, the set-top box 120 serves to demultiplex, demodulate, and convert to a viewable format the signals 350, 360, 370. These signals may then be passed to a television (not shown) or the consumer's personal video recorder 200. The PVR, of course, may store the broadcast signal(s) for later playback.

Additionally, a backchannel system 380 may be connected to the set-top box 120 and intelligence 310, and serves to gather consumer usage and profile information. In an alternate embodiment, the backchannel system 380 may be connected to the network 100 instead of the set-top box 120. The backchannel system 380 may monitor what shows and/or advertisements are viewed by a consumer, as well as which are ignored or skipped. Generally, the backchannel system 380 may operate via radio frequency (RF), standard telephone lines, Internet transmissions, microwave signals, and so forth. Further, the backchannel system may gather click-through data by tracking when a consumer presses various buttons on a remote control 220 associated with either the set-top box 120 or the PVR 200. For example, the backchannel system 380 may track whether a consumer responds to an enhanced television option or offer, such as an opportunity to instantly buy a product for sale on a shopping channel, responses to an on-screen survey, or simply when a consumer fast-forwards or rewinds a recorded broadcast stored on a PVR 200. This data may be transferred to the intelligence 310, which in turn may use the data to target advertising or special programs stored in the storage array 300 to a specific consumer. Generally, a consumer's profile information is stored in the storage array 300 or locally by the set-top box 120.

Targeted Advertisements

Generally, showing advertisements during a television broadcast is a hit-or-miss affair. The vast majority of broadcast viewers have no particular interest in advertisements and little use for the products featured. At any given point, however, some percentage of a potential broadcast audience will be in the market for an advertised product. In order achieve sufficient market penetration to reach interested audience members, advertisements must be played multiple times in multiple timeslots to everyone watching. With some luck, enough people having a need or desire for the advertised product will see the ad and purchase the goods or services shown. Unfortunately, this shotgun approach leads to viewer disinterest in advertising in general, which in turn causes viewers to ignore or fast-forward through advertisements contained in a recorded program. Where advertisements are targeted to a consumer's specific interests, however, the likelihood of a consumer watching the ads increases dramatically. A PVR 200 may be used to acquire and store a specific set of targeted advertisements, which may then be played back during a live broadcast, video on demand (VOD) provided by the headend 110, or while watching a taped program stored on the PVR 200 itself.

FIG. 4 displays a flowchart detailing the steps necessary to acquire a set of advertisements targeted to a consumer. This process may either be initiated by the present embodiment at set or random intervals, or deliberately begun by a consumer wishing to view specific types of advertisements. In the former case, the intelligence 310 may determine, based on data received via the backchannel system 380 or other data sources, ads likely to be of interest to a consumer. These advertisements may then be downloaded to a PVR 200 as necessary. Alternately, the intelligence 310 may simply download all advertisements available or a random subset thereof to the PVR 200 in order to ensure that at least some of the stored advertisements may be of interest to the consumer.

In the latter case, the consumer may specify which ads are of interest in a variety of manners, such as through the use of on-screen menus. For example, a consumer may be shopping for a new automobile, and so may access an “automobile advertisement” menu provided by the embodiment. This menu, in turn, may have a variety of selectable sub-menus to permit a consumer to provide ever more selective criteria and thus narrow the field of targeted advertisements. Continuing this example, the “automobile advertisement” menu may have “car,” “van,” “truck,” and “sport utility vehicle” sub menus. A consumer may then select one of these submenus, and be presented with additional sub-menus detailing more specific choices. This process may continue until the consumer has either exhausted the embodiment's menu choices or supplied what he believes is a sufficient amount of detail to capture relevant advertisements. As a final step in the example, a consumer might specify recording only those advertisements featuring automobiles of the sport utility type having four-wheel drive and a leather interior. This information is then added to the consumer's profile information for future use.

The targeted advertising recording process begins at start step 400. Once the process begins, the system determines in step 405 whether the consumer's PVR 200 is in use. If the PVR 200 is on and either recording or replaying a program, then step 410 is accessed. Otherwise, step 415 is executed.

In step 410, the system determines whether the active PVR 200 has more than one tuning device. If not, then no targeted advertisements may be stored and the process ends at step 445. If, however, the active PVR 200 has two or more tuning devices, step 415 is performed. The intelligence 310 retrieves in step 415 a consumer's profile information from the storage array 300 or set-top box 120, depending on where it is stored.

Next, the intelligence 310 executes step 420, in which it identifies those ads available in the storage array 300 matching the consumer profile. Following step 420, step 425 is accessed. In step 425, the system determines whether the advertisements identified in step 420 are broadcast by the headend 110 on a dedicated channel or frequency, or whether the PVR 200 must instead search through various broadcast channels to find suitable advertisements. That is, in one embodiment the transmission center 160 periodically broadcasts various advertisements across a dedicated channel. Should the intelligence 310 determine that one or more of these broadcast advertisements be of interest to a consumer based on his profile, it may instruct the consumer's PVR 200 to tune to the broadcast channel and record one or more interesting advertisements.

In the event that the headend 110 is indeed broadcasting advertisements, step 430 is next. Instep 430, the intelligence 310 instructs the PVR 200 to tune to the advertising broadcast channel. Once the proper channel is found, the PVR in step 440 records for storage those advertisements determined to be of interest to the consumer. Following step 440, the process ends in block 445.

If, however, step 425 returns a negative response, step 435 is accessed. In step 435, the PVR 200 simply scans available broadcast channels received across the network 100 for advertisements identified as matching the consumer's profile. Advertisements may contain non-displayable data embedded in a portion of the video signal not displayed on a standard television, such as in the VBI or overscan segments. Alternately, non-displayable data may be transmitted as separate packets in the programming signal data stream, such as the DVS 253 or DVS 380 standards. Generally, these transmission options are referred to as “embedded data.” This information may contain, among other things, a header identifying the advertisement. The header may consist of a variety of information, including, but not limited to, a unique advertisement number, a product identifier, a manufacturer or advertiser identifier, a product category identifier, and so forth. Any or all of these may be detected by a PVR 200 searching for advertisements matching a consumer's profile information, and thus suitable for recording and storage. The method for embedding such data in a portion of a video signal is well known to those skilled in the art. Once such ads are found, the system executes steps 440 and 445 as detailed above.

Of course, merely identifying and storing targeted advertisements does nothing to place such ads in front of a consumer. The advertisements must be shown to the consumer in order to have any value. This may be accomplished by two methods. First, the consumer may simply instruct the PVR 200 to play all targeted advertisements stored on the storage devices 240, 250. In such a case, the PVR simply sequentially plays the targeted advertisements for the consumer's viewing.

Alternately, however, the embodiment may replace pre-recorded or live commercials of little or no interest to a particular consumer with stored targeted advertisements. An exemplary method for inserting pre-recorded advertisements into a program or other video signal is shown in FIG. 5. This process may occur regardless of whether the PVR 200 is relaying a real-time broadcast from the network 100 or replaying a previously recorded program stored on a storage device 240.

The process begins at start step 500. Following step 500, the PVR 200 performs step 505, in which it locates embedded data included in an advertisement broadcast or transmitted separately via network packets, either as part of a prerecorded or live video signal. The embedded data may serve to indicate the beginning of the advertisement as opposed to a portion of a television show or other program. Once the PVR 200 detects this information, step 505 is complete and decision step 510 is accessed.

In step 510, the embodiment determines whether the advertisement about to be played is one which the consumer's profile information indicates may be of interest. Generally, the embedded data may indicate the contents of the advertisement, which may be matched against the consumer profile information. The embedded data may also serve only as a trigger instructing the PVR 200 or set-top box 120 to choose and queue a previously stored advertisement located on the storage medium 240, 250 which matches the consumer's profile information. Such determinations may be made by the set-top box 120 in an alternate embodiment.

If the embedded data and consumer profile information match, then step 520 is executed and the currently queued advertisement is played. Following step 520, the process ends in block 530.

Alternately, it may be determined in step 510 that the queued advertisement does not match the consumer's profile information. In this case, step 515 is accessed and a previously stored targeted advertisement is retrieved by the PVR 200 from a storage device 240, 250. In an alternate embodiment, the targeted advertisement may be retrieved from the storage array 300 instead of the storage device. In either case, step 520 is executed next, and the just-retrieved ad is played in lieu of the originally queued advertisement. Following step 520, the process ends at end step 530.

It should be noted that the speed of advertisement retrieval, whether from a local storage device 240, 250 or the storage array 300, is such that the consumer notices little or no delay in the video signal. To the consumer's perception, the substitution of the targeted advertisement for the queued ad is unnoticeable.

Alternate Display Formats During a Fast-Forward Operation

As previously mentioned, consumers may use their personal video recorders 200 to fast-forward or completely skip across advertisements rather than watching them. When this occurs, the advertisement's impact is diminished or lost entirely. However, by employing an alternate advertisement format viewable only during a fast-forward or skipping operation, the ad's impression may be maintained.

Generally, PVRs 200 may either digitally fast-forward across or skip an advertisement. When fast-forwarding, video portions of the advertisement are played back at high speed. When skipping, the entire advertisement is passed over, with no video displayed at all. Throughout this document, the term “fast-forward” is meant to embrace both fast-forward and skip operations, and any features or operations available during a fast-forward operation are also available during a skip operation.

Even during a fast-forward operation, segments of an advertisement are displayed on a television screen for a brief time because video signal replay is simply sped up. Instead of presenting a series of disjointed frames as is typically seen during a fast-forward playback, another embodiment of the present invention employs embedded data to create a unique advertising image. For example, the standard advertisement may include embedded data corresponding to a series of still frames, or storyboards, each of which will be displayed for a significant period of time when a consumer attempts to skip the advertisement. By storyboarding an ad, each still frame remains in sight for a greater period of time than the typical flicker of images resulting from fast-forwarding. The storyboarded advertisement thus conveys greater information and makes a stronger impression on a fast-forwarding consumer. As previously mentioned and discussed with respect to FIG. 4, such data may be embedded in a portion of the video signal not normally displayed, or again transmitted as dedicated data packets.

An advertiser may feel that the brief window afforded during a fast-forward operation to skip a normal advertisement is insufficient time to permit storyboarding. In such cases, a single video frame may be shown for the duration of the fast-forwarded advertisement. This video frame may be either a frame of the advertisement, for example, an I-frame as defined with respect to MPEG compression schemes or data sent as a portion of a programming signal. Additional data may be either embedded in the advertisement signal, or may be a separate data packet generally contained and multiplexed in a signal. The data may consist of text, graphics, audio, or a combination thereof for independent presentation or for use in conjunction with the I-frame display. The data may have a number of different formats and/or may be compressed, for example, via a compression scheme such as MPEG-4, whereby different audio, video, and graphics objects may be chosen for display depending upon accompanying instructions.

An example may serve to illustrate the above principles. If a consumer fast-forwards across an advertisement for, say, Uncle Bill's Pizza Delivery, a single frame may be shown for the duration of the fast-forwarded ad. This single frame may be an I-frame of the video advertisement or may be a hidden frame including nothing more than the company name (“Uncle Bill's”), product (pizza), and a price. Further, additional details may be overlaid on the I-frame as text or graphics. These details may be taken from data embedded in the advertisement itself, or synthesized from data transmitted separately in the network 100 data stream. Of course, the details of the single frame may vary widely, and the foregoing are simply examples and not limitations.

Further, because advertising is often sold on a local basis, networks 100 and storage arrays 300 located in different parts of the country may contain customized single frames or storyboards. Returning to the pizza example, a local broadcaster or cable operator might customize the single frame to include the telephone number of the nearest Uncle Bill's pizza franchise. This number, of course, could change for each cable operator's network 100. Thus, a cable operator located in Golden, Colo. may embed the telephone number for the Golden Uncle Bill's store, while the cable operator for midtown Manhattan may embed the telephone number for that franchise. Alternately, all local phone numbers for the desired markets could be provided in the advertising data stream as individual MPEG-4 graphic objects, whereby the appropriate local number graphic is selected for display based upon the cable subscriber's identification.

Additionally, embedded data displayed during a fast-forward operation is not limited to visual information. For example, the embodiment may have a jingle or short song associated with an advertiser contained in the non-viewable portions of an advertisement instead of a storyboard. The jingle would then play while the consumer fast-forwarded over the advertisement.

It should be noted that a pointer or retrieval command could be embedded in an advertisement instead of display data. For example, a command instructing the PVR 200 to retrieve a storyboard from the storage array 300 or a jingle from a POTS 210 line while fast-forwarding may be embedded in the VBI of an advertisement, or sent as a separate data packet, instead of the storyboard or jingle themselves. This may be done where the size of the visual or audio data intended to be displayed during the fast-forward sequence is too great to be embedded in the advertisement. Of course, the retrieval command could also instruct the PVR 200 to retrieve the alternate display format from a storage device 240, 250 located within the PVR itself.

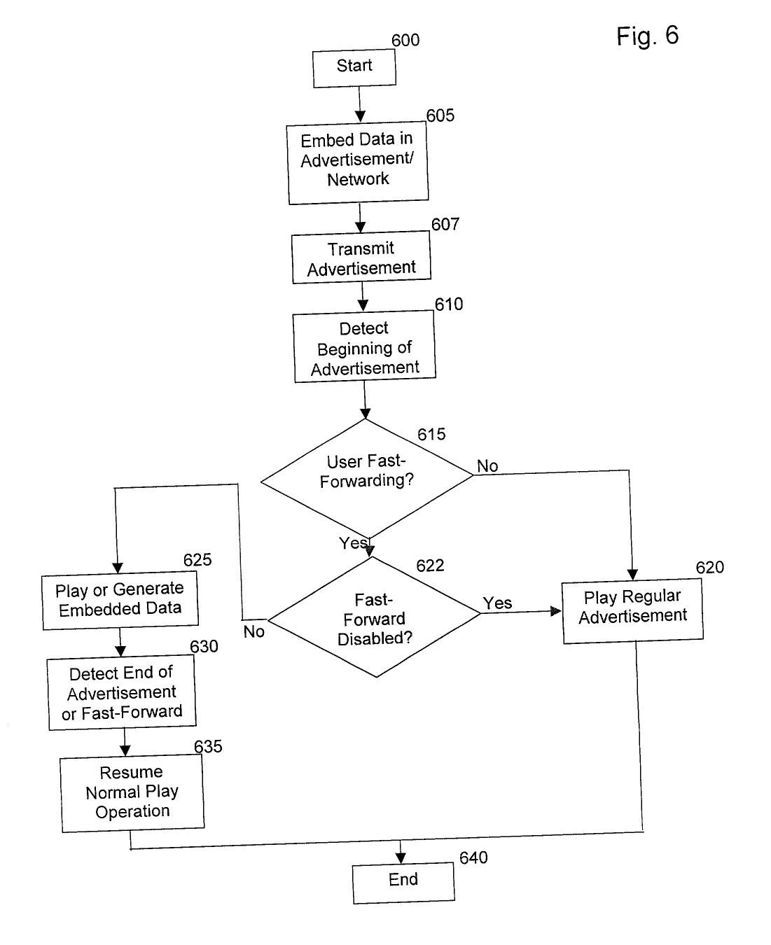

Turning now to FIG. 6, an example of a process for displaying alternate advertisement formats during a fast-forward operation may be seen. The process begins at start step 600 and proceeds to step 605. In step 605, the embodiment may embed alternate display data and commands to retrieve such data. The data may be embedded in either the non-displayable portions of an advertisement, separate data packets, or in programming or network signals. For example, the data may be retrieved from a network using Society of Cable Telecommunications Engineers (SCTE) standards, such as the DVS 253 standard for cueing advertisements, or the DVS 380 API message, for inserting advertisement data received from a network. All of these processes are colloquially referred to as embedding the data in the advertisement.

Once the data is embedded in the advertisement, the spot is transmitted across the network 100 in step 607. Following step 607, the PVR detects the embedded data at the beginning of the advertisement in step 610. Again, this may occur either during real-time display of an advertisement received from the network 100, or while playing back previously recorded material.

Decision step 615 is next. In step 615, the PVR 200 determines whether the user has initiated a fast-forward operation, typically by pressing the fast-forward control 230 on a remote 220. If no fast-forward is requested, the advertisement is played normally in step 620, after which the process ends in block 640. If, however, the user has requested that the PVR 200 fast-forward over the advertisement, the embodiment executes step 622.

In step 622, the embodiment determines whether the fast-forward feature of the PVR 200 or receiver 120 has been disabled. If so, then step 620 is accessed, and the normal advertisement is shown. Otherwise, the embodiment proceeds to step 625.

In step 625, the embodiment retrieves the embedded data and displays it, or retrieves an alternately formatted advertisement in lieu of the regular advertisement. Where the embedded data is itself intended for display, it is simply shown by the PVR 200 instead of the regular ad. If the embedded data instead comprises a pointer or retrieval command, as described above, then the PVR 200 requests display data from the appropriate source and displays the received data. It should be noted that the embedded (or requested) data may change throughout the advertisement, as in the case of a storyboard. For example, the first one hundred thirty frames of a real-time advertisement, corresponding to approximately five real-time seconds, may contain embedded data instructing the PVR 200 to display a first frame showing an advertiser's name. The next one hundred twenty frames might include embedded data corresponding to a frame of a person holding the advertiser's product, and a final one hundred twenty frames may contain embedded data instructing the PVR 200 to display a frame with a toll-free number. Of course, each of the above frame sets may instead include as embedded data a retrieval command instructing the PVR 200 to pull from a different source the frames described above.

As previously noted in the pizza example given above, the embodiment may also generate display data or a frame from an I-frame and graphic objects transmitted either as embedded data or as data packets within the network 100. In this embodiment, the generated data is displayed in step 625.

Next, the PVR 200 detects the end of the regular advertisement or the fast-forward operation in step 630. Once the advertisement end or fast-forward termination is detected, step 635 is executed. In step 635, the PVR 200 ceases playing any alternate advertisement formats and resumes normal display during the remainder of the fast-forward operation. The process then terminates in end step 640.

Advertisement Updating

Another embodiment of the present invention may update on the fly stale advertisements, whether played during a live broadcast or from a recording. “Stale” advertisements are commercials which may contain limited time offers, sale dates, or other time-sensitive information, or may simply be prior advertisement campaigns scheduled to be replaced by updated advertisements. Such advertisements have little or no value if played beyond the cutoff date of the time-sensitive information. Accordingly, another embodiment of the present invention manifests the ability to replace a stale advertisement with an updated one having accurate information.

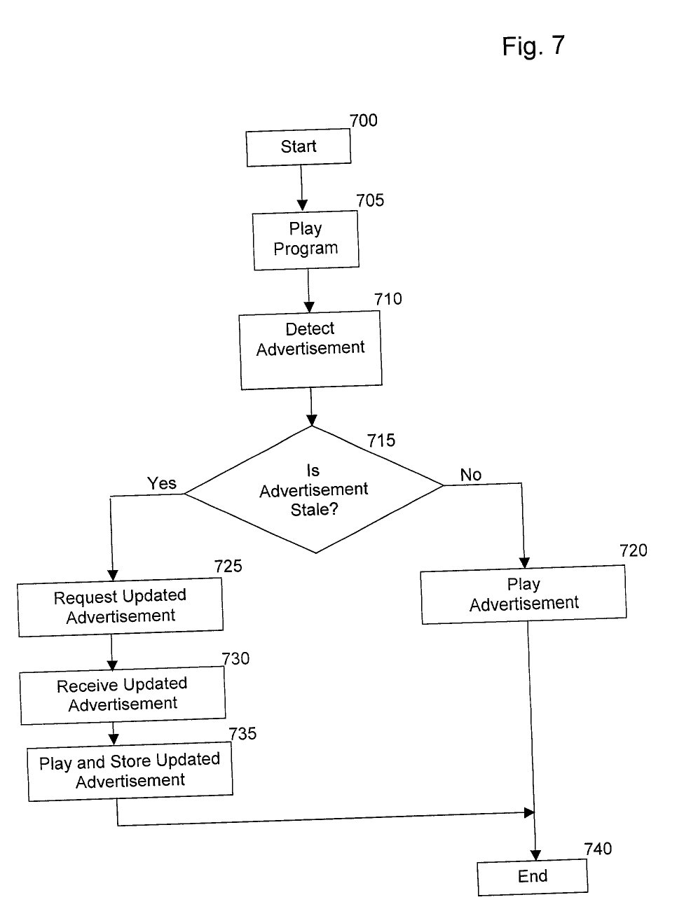

A process for detecting and replacing stale advertisements is shown in FIG. 7. It should be noted that this process may be carried out either in real time or a non real time manner, as necessary. In a non real time (background) process, an embodiment may continually scan through a programming schedule provided via the headend 110 to determine which, if any, upcoming advertisements are stale while a consumer watches a normal programming signal. By performing the above task as a background operation, the embodiment may detect stale advertisements before they are scheduled to play, thus permitting additional time to replace or freshen the advertisement.

The process begins at start step 700. From there, step 705 is accessed. In step 705, a program is played on a television 130. The program may either be transmitted from the headend 110, across the network 100, received by the set-top box 120, and passed to the television, or may be played from recording stored on a storage medium 240, 250 located within a PVR 200.

The program generally contains one or more advertisements. These ads may contain embedded data identifying the advertisement and/or time-sensitive information giving a date past which the ad is no longer to be shown. The process of embedding data within an advertisement was more fully discussed with respect to FIG. 4. Generally, one or more frame of the advertisement are embedded with this data, and often each frame is as well. In step 710, the embodiment detects the beginning of an advertisement airing during a break in the program. In an alternate embodiment performing this process as a background task, the embodiment may simply detect the presence of an advertisement in a programming schedule, as described above.

The embodiment typically detects the advertisement either by receiving the embedded data, or receiving a signal indicating the cessation of the program and beginning of an advertisement. This signal may be, for example, a dual-tone frequency modulated (DTMF) signal, a DVS 253 or 380 signal, or any form of embedded command data of an analog or digital nature. Such signals, for example, are often encoded in programs or other audiovisual signals in order to mark for a broadcaster specific areas of a signal in which advertisements are to be inserted. Step 710 may be executed by a PVR 200, the intelligence 310, a set-top box 120, or various other elements of the embodiment. With respect to the background process mentioned above, the schedule may contain embedded data indicating the nature of the advertisement.

Following step 710, the embodiment determines in step 715 whether the time-sensitive information embedded in the advertisement indicates that the advertisement is now stale. If not, then the ad is played normally in step 720. Following step 720, the process terminates in end step 740.

However, if the embodiment decides that the advertisement is stale, step 725 is accessed. In step 725, the embodiment requests an updated advertisement. In response to this request, the intelligence 310 determines which advertisements may be played in placed of the stale ad according to a set of business rules. For example, the intelligence 310 may apply rules allowing only advertisements by the same advertiser to be played in place of a stale commercial, rules requiring an updated version of the same advertisement, rules requiring that an updated advertisement feature the same type of merchandise as a stale advertisement, and so forth. Once the updated advertisement is determined, the intelligence 310 (or the PVR 200 itself) instructs the storage array 300 to transmit the ad, either in place of the stale advertisement (in the case of a real-time broadcast) or across the network substantially immediately to take the place of a recorded stale advertisement. In an alternate embodiment, the intelligence 310 may instruct a PVR 200 that has previously recorded advertisements to release an updated advertisement from a storage device 240, 250 instead of requesting an updated ad from the storage array 300. The process of identifying and recording advertisements was discussed more fully above.

The set-top box 120 may maintain a video library comprising an index of the current advertisements available to replace stale ads. The advertisements indexed in the video library may be either pre-downloaded to a PVR 200 or stored at the headend 110, as discussed above. Occasionally, the set-top box 120 may update this library by periodically querying the headend 110 to determine what freshened advertisements are available. This video library may be consulted in order to determine whether an updated or current advertisement must be downloaded, or is available for local playback.

The updated advertisement is received in step 730, either from the storage array 300 or the storage device 240. Next, the embodiment plays the updated advertisement in place of the stale ad in step 735. The updated advertisement may also be stored on the PVR 200 for later playback. After step 735, the process terminates at end block 740.

It should be noted that the embodiment performs the real time process shown in FIG. 7 substantially immediately, in order to reduce or eliminate any lag or pauses noticeable to a consumer. Alternate embodiments, of course, may preserve such lag if necessary or desirable. Of course, when the process of FIG. 7 is implemented as a background process, real time operation is unnecessary.

Reward-Based Content

Another embodiment of the present invention provides consumers with reward-based content. Generally speaking, reward-based content is a program or other audiovisual signal desirable to a consumer that may be obtained only after the consumer performs some task. For example, free content may be provided in return for the consumer filling out a survey, purchasing a different or premium program, watching an informational program prior to the content, and watching advertisements contained in the content. Although the following description discusses reward-based content wherein the task is watching one or more advertisements, it should be understood that any of the above mentioned tasks may be implemented by the embodiment.

Oftentimes, reward-based content is paid for entirely by an advertiser. Each advertiser may select reward-based content tailored to pique the interest of a specific type of consumer, and thus attach an advertisement to content virtually guaranteed to reach an interested audience.

For example, a movie might be provided via a video-on-demand (VOD) service. Rather than following a normal subscription method and requiring a consumer to pay for the movie, the network provider may choose to fund the VOD service via advertisements placed by various advertisers. In this manner, the consumer may receive VOD free of charge, while the advertisers reach an additional audience. Further, by carefully selecting the advertisers linked to any given VOD, the likelihood that a consumer may be interested in the products or services advertised may be increased. However, in order to ensure value for the advertisers, the broadcaster or VOD provider must ensure that the advertisements are seen by the consumer. This may be accomplished via the concept of reward-based content.

FIG. 8 displays a flowchart detailing the process followed by an embodiment providing reward-based content. The process begins at start step 800. Following step 800, the embodiment executes step 805 in which a PVR 200 retrieves reward-based content. The reward-based content may either be played immediately upon receipt, or may be recorded on a storage device 240. In an alternate embodiment, a set-top box 120 may retrieve the reward-based content, bypassing the PVR 200 completely.

In step 810, the embodiment plays the reward-based content. Again, the content may be played as it is received, or may be replayed from a stored recording. After step 810 is completed, step 815 is accessed. In step 815, the embodiment detects the beginning of one or more advertisements, collectively referred to as an “advertisement stream,” contained in the reward-based content. The advertisement stream may be placed at the beginning, end, or within the reward-based content, and more than one advertisement stream may be placed in a single piece of content. Methods for detecting the beginning of an advertisement or advertisement stream were more fully discussed with respect to FIGS. 4, 5, and 6.

Once the embodiment detects the start of an advertisement, it may disable the PVR 200 or set-top box 120 remote 220 in step 820 via a software command sent from the headend 110 to the consumer's PVR or set-top box. Alternately, in the case of a prerecorded program played back from a storage device 240, 250, the PVR 200 may automatically disable its own remote 220. Yet another embodiment may disable only certain functions on a remote, or may permit the remote to completely function. The software commands and methods for disabling such electronics are well known to those skilled in the art. Since a PVR 200 (and often a set-top box 120) has no operational controls on its face besides a power button, disabling the remote 220 effectively removes the consumer's ability to issue any commands to the PVR. Accordingly, once the remote is disabled, a consumer cannot fast-forward or otherwise skip the reward-based content. A consumer may only choose to turn off the PVR 200, thus terminating playback of the reward-based content in its entirety, permit the advertisements to play at a normal pace, or change the channel. Of course, alternate embodiments may permit additional functionality, as desired.

Next, the embodiment detects the end of the advertisement stream in step 825. The end of an advertisement may be signaled by a cessation of embedded data in the advertisement or new dedicated data embedded in the signal indicating that a program is about to resume, for example. After this step, decision block 830 is accessed.

In step 830, the embodiment determines whether all advertisements in the advertisement stream were watched. If so, then the embodiment resumes playing the reward-based content normally in step 835, after which the process ends at termination block 845. If, however, the user somehow skipped over portions of the advertisement stream, the reward-based content playback is terminated in step 840. The embodiment may also instruct the intelligence 310 not to permit the user to access any additional reward-based content for a period of time.

In an alternate embodiment having an advertisement stream at the end of reward-based content (that is, after the reward-based content has been seen in full), the embodiment may check in step 830 whether the entire advertisement stream was played in its entirety, or the last time the content was viewed. This may happen, for example, where the content is stored on a storage device 240 within a PVR 200. If step 830 yields a negative determination in the alternate embodiment, then the embodiment proceeds to terminate all playback of the reward-based content in step 840 until the advertisements are viewed. The embodiment may, for example, remove the reward-based content from the storage device 240, or may implement a business rule or instruction in the intelligence 310 barring that user from accessing another copy or stream of the reward-based content, or even barring the consumer from accessing any future reward-based content.

In any event, after step 840, the process terminates in end state 845.

Updated Advertising Sales

Because PVRs 200 are inherently designed to permit time-shifting of programs and/or audiovisual signals and associated advertisements, many people use this function in order to deliberately skip commercials. By showing only targeted advertisements, consumers may be induced to view the commercials regardless of time-shifting capability. Further, by providing updated or targeted advertisements in place of stale or unfocused advertisements, advertisers may have the ability to reach consumers during a time block not originally purchased. For example, an advertiser may find his commercial for diamond jewelry playing during a live broadcast to a specific group of consumers identified as interested in jewelry in lieu of a household cleaner ad, despite the fact that the jewelry advertiser did not purchase that particular air time. Accordingly, the present invention also lends itself to a new method for selling advertising not by specific time blocks, but instead by number of impressions or plays. That is, broadcasters may now be able to generate advertising revenue not only for commercials playing at 8:30 P.M. on Thursday nights, but also for targeted advertisements played in lieu of the standard commercial in that time slot. Further, tracking and billing reports may be generated by collecting advertisement viewing data from individual PVRs 200 via the backchannel system 380.

Conclusion

As will be recognized by those skilled in the art from the foregoing description of example embodiments of the invention, numerous variations on the described embodiments may be made without departing from the spirit and scope of the invention. For example, an alternate embodiment of the present invention may permit a user to select from among multiple targeted advertisements matching his profile “on the fly,” so to speak, rather than simply choosing one for him. Further, while the present invention has been described in the context of specific embodiments and processes, such descriptions are by way of example and not limitation. Accordingly, the proper scope of the present invention is specified by the following claims and not by the preceding examples.

We claim:

1. A method for providing reward-based content, comprising:
downloading reward-based content having an embedded advertisement stream comprising at least one advertisement within the reward-based content;
playing the reward-based content;
detecting the beginning of the advertisement stream;
in response to detecting the beginning of the advertisement stream, disabling a remote control; and
detecting the end of the advertisement stream.

2. The method of claim 1, wherein the step of playing the reward-based content comprises playing the reward-base content on a personal video recorder.

3. The method of claim 2, further comprising:
recording the reward-based content as a stored recording on the personal video recorder; and
the step of playing the reward based-content on the personal video recorder comprises playing the reward-based content from the stored recording on the personal video recorder.

4. The method of claim 2, wherein the step of disabling a remote control comprises disabling via a software command a remote control associated with the personal video recorder.

5. The method of claim 4, wherein the software command is transmitted from a transmission center.

6. The method of claim 2, further comprising:
determining that the entire advertisement stream was shown at a normal playback speed;
in response to determining that the entire advertisement stream was shown at a normal playback speed, continuing to play the reward-based content; and
otherwise, terminating the reward-based content.

7. The method of claim 1, wherein the step of detecting the beginning of the advertisement stream comprises locating embedded data placed within a non-visible portion of the advertising stream.

8. The method of claim 7, wherein the embedded data comprises an indication that the reward-based content has ended.

9. The method of claim 1, wherein the remote control is associated with a receiver.

10. The method of claim 6, further comprising:
in response to determining that the entire advertisement stream was not shown at a normal playback speed, barring all further downloads of reward-based content for a period of time.

11. The method of claim 1, wherein the step of detecting the beginning of the advertisement stream comprises locating embedded data transmitted as a dedicated data packet.

12. The method of claim 1, wherein the step of detecting the beginning of the advertisement stream comprises locating embedded data contained within the vertical blanking interval of the advertisement stream.

13. The method of claim 1, wherein the step of detecting the beginning of the advertisement stream comprises locating embedded data contained within the horizontal overscan of the advertisement stream.

14. A method for detecting and replacing stale advertisements, comprising:
detecting the beginning of a first advertisement contained in a programming signal;
determining that the first advertisement is stale;
in response to determining that the first advertisement is stale, requesting an updated advertisement;
receiving the updated advertisement; and
playing the updated advertisement.

15. The method of claim 14, wherein the step of playing the updated advertisement is performed substantially immediately after the step of detecting the beginning of a first advertisement contained in a programming signal.

16. The method of claim 14, further comprising embedding embedded data in a non-visible portion of the first advertisement.

17. The method of claim 16, wherein the step of detecting the beginning of a first advertisement contained in a programming signal comprises detecting the embedded data.

18. The method of claim 16, wherein the non-visible portion of the first advertisement comprises the vertical blanking interval.

19. The method of claim 16, wherein the non-visible portion of the first advertisement comprises the horizontal overscan.

20. The method of claim 17, wherein the embedded data comprises a time stamp indicating the last time at which the first advertisement is to be played.

21. The method of claim 20, wherein the step of requesting an updated advertisement comprises requesting from a storage location an advertisement having a time stamp later than the current time.

22. The method of claim 14, further comprising transmitting embedded data as a separate data packet in the programming signal.

23. The method of claim 21, wherein the storage location comprises a storage device located within a personal video recorder.

24. The method of claim 21, further comprising:
recording the programming signal on a storage device located within a personal video recorder; and
wherein the step of playing a programming signal comprises playing the programming signal from the storage device.

25. A method for providing targeted advertising, comprising:
compiling consumer profile information;
determining whether a first advertisement matches the consumer profile information;
in the event that the first advertisement matches the consumer profile information, recording the first advertisement; and
in the event that the first advertisement does not match the consumer profile information, ignoring the first advertisement.

26. The method of claim 25, further comprising:
determining whether the first advertisement is broadcast by a transmission center on a dedicated frequency;
in the event that the first advertisement is broadcast by the transmission center on the dedicated frequency, tuning a receiver to the dedicated frequency;
in response to tuning a receiver to the frequency, recording the first advertisement on a personal video recorder;
in the event that the first advertisement is not broadcast by the transmission center on the dedicated frequency, scanning a set of broadcast frequencies to locate the first advertisement; and
in response to locating the first advertisement, recording the first advertisement.

27. The method of claim 26, further comprising:
playing a programming signal;
detecting a second advertisement having embedded data in the programming signal;
determining whether the second advertisement matches the consumer information profile;
in response to determining that the second advertisement does not match the consumer information profile, retrieving the first advertisement;
inserting the first advertisement in the programming signal; and
playing the first advertisement.

28. The method of claim 27, wherein the embedded data comprises information indicating the contents of the second advertisement.

29. The method of claim 28, wherein the step of determining whether the second advertisement matches the consumer information profile comprises:
receiving the embedded data; and
comparing the contents of the second advertisement to the consumer information profile.

30. The method of claim 27, wherein the step of determining whether the second advertisement matches the consumer information profile comprises comparing the embedded data to the consumer information profile.

31. The method of claim 27, wherein the step of determining whether the second advertisement matches the consumer information profile comprises reviewing the embedded data.

32. A method for providing an alternate display format for an advertisement during a fast-forwarding operation, comprising:
playing on a video device the advertisement having embedded data;
detecting that the video device is replaying the advertisement at a playback speed exceeding a normal playback speed;
in response to detecting that the video device is replaying the advertisement at a playback speed exceeding a normal playback speed, retrieving the embedded data;
detecting the end of the advertisement; and
in response to detecting the end of the advertisement, terminating retrieving the embedded data.

33. The method of claim 32, wherein the embedded data comprises a single video frame.

34. The method of claim 33, further comprising:
displaying the single video frame instead of the advertisement during the fast-forward operation;
further in response to detecting the end of the advertisement, terminating displaying the single video frame.

35. The method of claim 32, wherein the embedded data comprises a plurality of storyboard frames.

36. The method of claim 35, further comprising:
in response to retrieving the embedded data, displaying the plurality of storyboard frames; and
further in response to detecting the end of the advertisement, terminating displaying the plurality of storyboard frames.

37. The method of claim 36, wherein the step of displaying the plurality of storyboard frames comprises:
retrieving a first portion of the embedded data;
displaying a first storyboard frame corresponding to the first portion of the embedded data until the first portion of the embedded data is no longer retrieved;
retrieving a second portion of the embedded data; and
displaying a second storyboard frame corresponding to the second portion of the embedded data until the second embedded datum is no longer retrieved.

38. The method of claim 32, wherein the embedded data comprises audio data.

39. The method of claim 38, wherein the audio data is a song.

40. The method of claim 39, further comprising:
playing the song;
detecting the end of the advertisement; and
terminating playing the song.

41. The method of claim 32, further comprising:
detecting the end of the fast-forward operation; and
in response to detecting the end of the fast-forward operation, terminating retrieving the embedded data.
